(19) United States
(12) Patent Application Publication
(10) Pub. No.: US 2008/0138520 A1
(43) Pub. Date: Jun. 12, 2008

(54) Method and System For Fashioning Artificial Nails Having Colorful Patterns

(76) Inventor: Loi Q. Chu, Batavia, IL (US)

Correspondence Address: MURPHY DESMOND S.C., P.O. BOX 2038, MADISON, WI, 53701-2038, US

(21) Appl. No.: 11/946,981

(22) Filed: Nov. 29, 2007

Related U.S. Application Data
(60) Provisional application No. 60/873,756, filed on Dec. 8, 2006.

(51) Int. Cl. A45D 31/00; B05D 1/38

(52) U.S. Cl. 427/265; 132/200; 132/73

(57) ABSTRACT

The present invention is directed to a method of fashioning artificial nails having colorful patterns by applying a first layer of a first colored polymer to a natural or artificial fingernail. Portions of the first polymer are scraped off with a gouge to create a defined border. A second application of acrylic powder of a second color is applied along the border defined above so that the second application is substantially an extension of the first colored polymer. In a further embodiment, portions of the second color can also be scraped off with gouge to define a second edge, in order to form additional patterns. A system is created for fashioning artificial nails having colorful patterns comprising an elongated gouge having a handle end and a fashioning end. The fashioning end has an end that has a width and curvature that generally corresponds to the width and contour of the nail. In a further embodiment, the system has several gouges having different shaped ends to create different patterns. Further, the system may comprise a set of gouges that varies the width and curvature for each different shaped end to reflect different nail shapes and sizes. In some cases, it is desirable to provide for left-handed tools and right handed tools. Furthermore, the system can further comprise at least two different colored polymers, wherein the two colors may be the same, except that one contains an additional attribute, such as glitter or transparency, that provide a different visual effect.

### RELATED APPLICATION

The present invention claims priority from and is a continuation-in-part of U.S. Provisional Patent Application 60/873,756 filed Dec. 8, 2006.

### BACKGROUND OF THE INVENTION

The present invention is directed to a method of fashioning artificial nails having multi-colored patterns. The present invention is also directed to a system comprising a gouge having a curved indent at one end that generally follows the vertical curvature of the fingernail.

Methods for artificially enhancing the appearance of and protecting fingernails are well-known. These include methods which lengthen, thicken, or alter the shape and color of the fingernails. The application of a polymer layer overlay is one such method. The polymer layer may be applied to an artificial fingernail extender (generally preformed acetate or vinyl plastic) which is glued or otherwise attached to the fingernail. Alternatively, the polymer layer may be applied directly to the fingernail or, if the extender does not fully cover the fingernail, to both the extender and the fingernail.

Numerous polymers such as, but not limited to, acrylic resin, polyester resin, thermoplastics, and thermosetting polymers are known in the manicure art. Acrylates have proven to be particularly useful in the artificial fingernail art. Compositions used to form an acrylic polymer layer are well-known. Examples of acrylic compositions include, but are not limited to: pastes; combinations of liquid monomers and polymer powders; a liquid polymer/monomer combination and a powder polymer; or a gel. Components may include, but are not limited to, acrylic acid and esters thereof; methacrylic acid and esters thereof; acrylic anhydrides; acrylamides; glycol esters of acrylic acid monomers; acrylonitrile; methacrylate monomer and polymer liquids; and acrylate powders.

One popular artificial appearance is the French manicure, where a distinct border is formed between two colors. Typically the colors are a flesh or pink color over the portion of the fingernail which covers the finger (generally referenced as the nail bed), and a white color over the portion of the fingernail which extends beyond the finger (generally referenced as the nail tip). Such French manicures have been known to be applied to natural nails, or extenders. Well-defined French manicure borders are difficult to fashion. Methods have been devised to define such borders. U.S. Pat. No. 6,745,486 B2 to Stenson-Buck (2004) discloses a drill that scores a defined border to separate two colors. U.S. Pat. No. 5,778,903 to Tran et al. (1998) discloses an acrylic cutter that impresses a curved line on acrylic nails to achieve a French manicure look. U.S. Pat. No. 5,927,293 to Halpern (1999) discloses the use of a dam to define two regions where acrylic of one color is applied to one region and acrylic of a second color is applied to the other region to form a well-defined boundary for a French manicure. In Halpern, the dam is left on the nail after the border is defined.

It is also known to apply a polymer overlay, and then apply fingernail polish or a second polymer overlay over the first layer by free hand paint brushing to create color patterns or tiny sculptures such as flowers and flamingos. The prior art is not known to disclose a versatile method of creating a multi-pattern, multi-color overlay as disclosed herein.

### BRIEF SUMMARY OF THE INVENTION

The present invention is directed to a method of fashioning artificial nails having multi-colored patterns by applying a layer of polymer of color one to a natural fingernail or an artificial fingernail extender. Because acrylic is currently the polymer of choice, the descriptions below will be directed to acrylic. It must be understood that the invention is not defined by the polymer used, and that any polymer that can be used in this art are within the scope of the invention. Portions of the acrylic powder of color one are scraped off with a gouge to create a defined edge. A second application of acrylic powder of color two is applied along the edge so that the second application becomes substantially an extension of the color one layer. In a further embodiment, portions of the second color can also be scraped off with gouge to define a second edge, in order to apply color three or alternatively color one. Many colors and many patterns may be fashioned by applying a color, scraping off a portion to define an edge, then applying another color.

The present invention is also directed to a system for fashioning artificial nails having colorful patterns comprising an elongated gouge having a handle end and a fashioning end. The fashioning end has a tip that has a width and curvature that generally corresponds to the width and contour of the natural fingernail. In a further embodiment, the system comprises several gouges having different shaped tips that created different patterns. Further, the system may comprise a set of gouges that varies the width and curvature for each different shaped tip to reflect different fingernail shapes and sizes. For example while a gouge having a crescent shape may be used for both the thumb and the pinky, it would be more precise and convenient to use crescent-shaped gouges having widths and curvatures that more substantially fit the particular digit being manicured. Furthermore, the invention can further comprise two different colored polymers, such as acrylic powders. Finally, nothing precludes the invention from being applied to toenails, although long toenails may be uncomfortable in a shoe. Herein, the disclosure will be directed to fingernails, with the understanding that the method and the system are also applicable to toenails.

### BRIEF DESCRIPTION OF THE DRAWINGS

FIG. 1 illustrates a prior art artificial nail in a cross section of a fingernail with a polymer layer overlay, having a layer of fingernail polish or a second layer of polymer applied on the overlay to provide pattern and/or color.

FIG. 2 illustrates an artificial nail in accordance to the present invention in a cross section of a fingernail with a polymer layer overlay comprising three sections, each of a different color.

FIG. 3 illustrates a hand having a different design on each digit.

FIG. 4 illustrates a multi-colored pattern comprising a circular center.

FIG. 5 illustrates two different patterns created from the same three colors.

FIG. 6 is a perspective view of four gouges each having a different fashioning end.

FIG. 7 is a top (concave) elevation view of the four gouges of FIG. 6.

FIG. 8 is a bottom (convex) elevation view of the four gouges of FIG. 6.

FIG. 9 is a view from the fashioning end (front) of the four gouges of FIG. 6.

FIG. 10 is a side view of the four gouges of FIG. 6.

FIG. 11 is a side view opposing the side view of FIG. 10.

FIG. 12 illustrates a pattern formation progression where a flat gouge defined a horizontal (relative to the fingertip) border and a diagonal border.

FIG. 13 illustrates a progression of a pattern formation using a V-gouge to define two V-shaped borders.

FIG. 14 illustrates a progression of a pattern formation using a crescent gouge, to define two crescent-shaped borders.

FIG. 15 shows a progression of a pattern formation using a half-crescent gouge to define two diagonal curves of different slopes.

### DETAILED DESCRIPTION OF THE INVENTION

The present invention provides for the formation of a single polymer layer on a fingernail, wherein the polymer layer has an artistic pattern of at least one color. The invention will be discussed in the context of applying acrylic polymer layers. As discussed above, the invention is not limited to acrylic polymers, but may be applied to other polymers that are known in the artificial nail art.

The system in accordance with the present invention comprises an elongated gouge having a handle end and a fashioning end. For the simplicity sake, the fashioning end will be the front, while the handle end will be the back. The bottom will be defined as the convex side of the tool, while the top will be defined as the concave side of the tool. Further, although the invention can be used on natural nails, artificial nails, combination thereof and even toenails, the descriptions herein will use fingernails as examples.

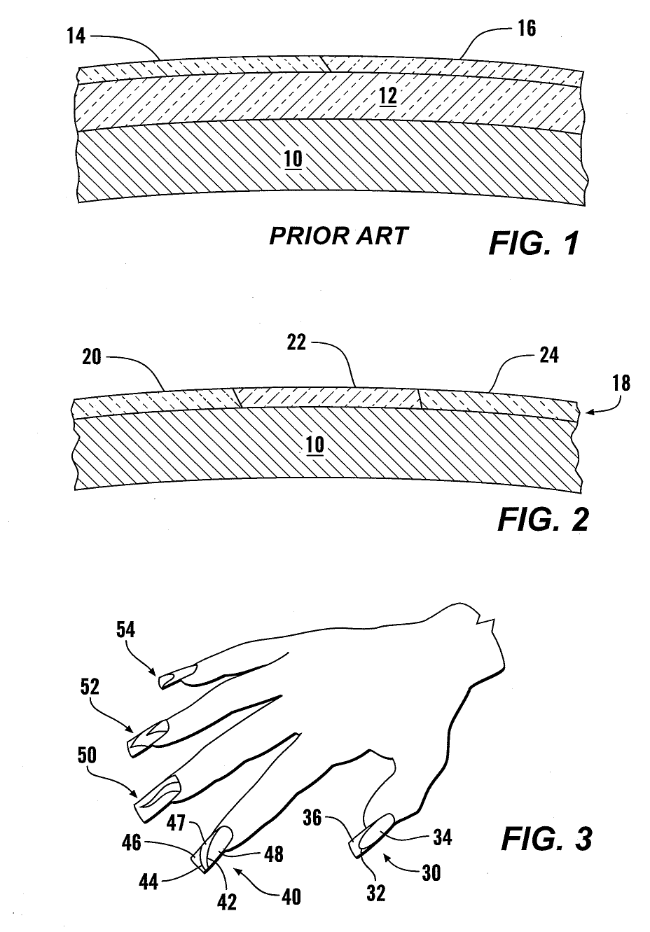

FIG. 1 illustrates a prior art method of providing colors and patterns on a fingernail 10 where a polymer overlay 12 is applied on the fingernail, and either a polish or a second coating of polymer is applied on top of the overlay in order to provide color or pattern to the fingernail. As shown, a first polish 14 covers a portion of overlay 12 while a second polish 16 covers another portion of overlay 12. FIG. 2 illustrates a polymer layer 18 having three different sections 20, 22 and 24, where each section has a different color formed in accordance to the method of the invention. Instead of just a superficial application of color on a polymer overlay, each color is incorporated into and present throughout each section of the overlay.

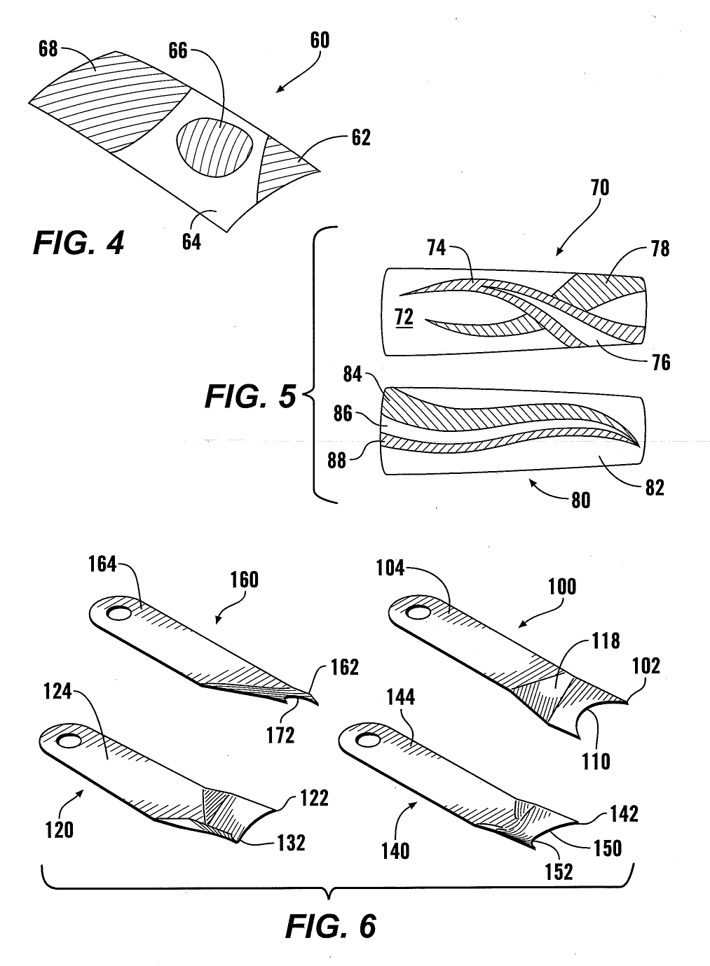

FIGS. 3, 4, and 5 illustrate the multitude of patterns and colors that can be fashioned by the method and system disclosed herein. FIG. 3 illustrates a hand on which each fingernail has a different pattern. Pattern 30 on the thumb most closely resembles the French manicure that is currently popular among clients. However, pattern 30 is slightly modified in that the border does not correspond exactly with the end of the nail bed, but has a U-shaped border 32 between the two sections 34 and 36. Pattern 40 illustrates two diagonal curved borders 42 and 44 that separate three sections 46, 47, and 48. Here all three sections may have a different color, or section 47 may provide a separation between two sections of the same color. In the context of this invention, colors can include the absence of color, white and black. Colors are also different if there are differences—some subtle, others readily apparent—in shade, in addition of substances such as glitter and in transparency of the colors. On the other digits, pattern 50 illustrates a vertical pattern, pattern 52 illustrates a V-shaped pattern and Pattern 54 illustrates a U-shaped pattern that is opposite of that in pattern 30. FIG. 4 illustrates a particularly complex pattern 60 having at least four sections 62, 64, 66, and 68, one of which is a circular pattern 66. FIG. 5 compares two different patterns formed from the same four colors. In pattern 70, the background section 72 has sections 74 and 76 forming a diagonal curve in one direction, while section 78 forms a diagonal curve in an opposing direction. In pattern 80, a corresponding background section 82 is substantially bisected by three sections 84, 86 and 88 that form a single vertical curve.

The patterns are formed by a method and a system for fashioning such patterns, wherein the system comprises at least one gouge. In an embodiment, four different shaped gouges are used as shown in FIGS. 6-11. In a further embodiment, the four different shaped gouges each belong to a set of gouges having varying widths and curvatures to conform to different sized fingers. In the present disclosure, the four different gouges will be labeled the flat gouge 100, the V-gouge 120, the crescent gouge 140, and the half-crescent gouge 160, with respective fashioning ends 102, 122, 142 and 162, and handles 104, 124, 144 and 164. As indicated above, for a frame of reference the fashioning ends are designated as the front of the gouge, while the handle ends are designated as the back of the gouge. Each gouge also has a top side (defined above as the concave side), 106, 126, 146 and 166, respectively, and a bottom side (defined as the convex side), 108, 128, 148 and 168, respectively.

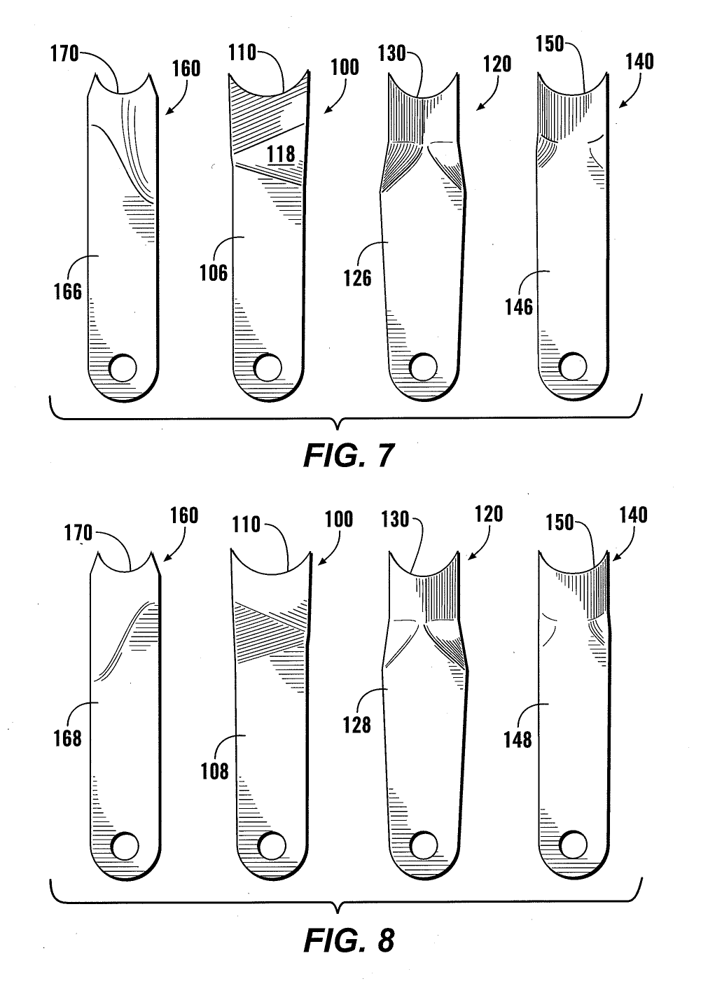

Flat gouge 100 appears to be misnamed because the device illustrated is not flat. However, the fashioning end 102 on each flat gouge is substantially flat. The crimp 118 that forms an angular Z to one side of the handle is not necessary for the ultimate function of this gouge, but provides easier handling of the gouge by the user. Having the crimp 118 to one side provides for use by the left or the right hand simply to flipping between the top and the bottom of the gouge. In this sense, there is no top or bottom of the flat gouge, simply a left handed side or a right handed side. As discussed, the fashioning end is flat from the top to the bottom, but has a front towards-back concave recess 110 best seen in FIGS. 7 and 8. In an embodiment, the curvature of the recess generally conforms to the convex contour of a fingernail.

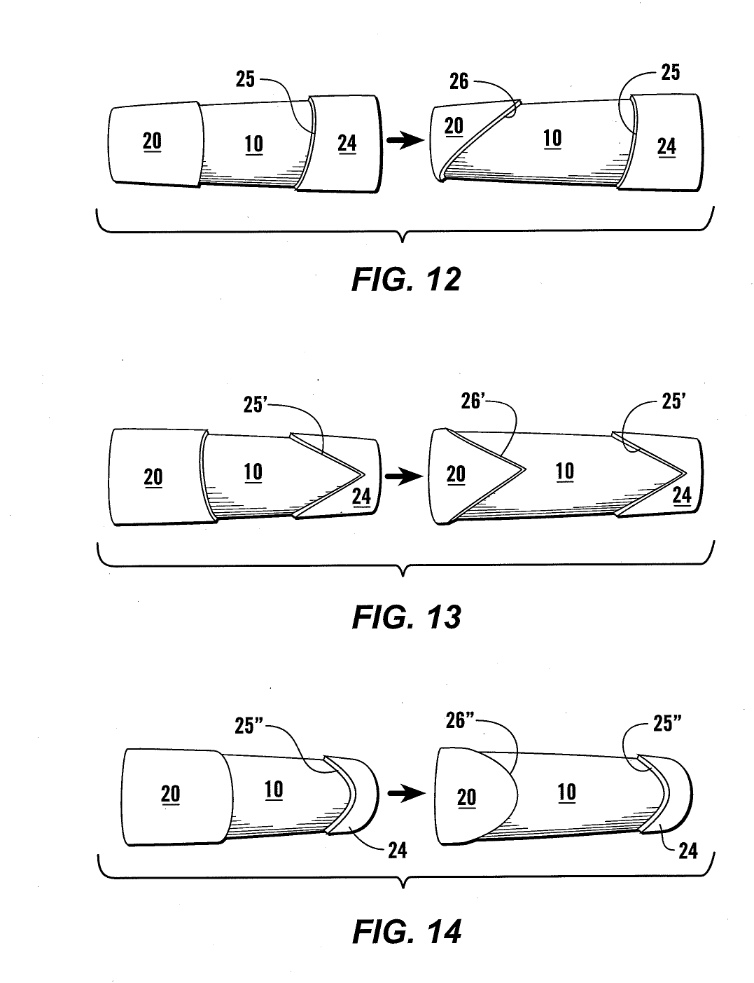

When the flat gouge is used, it provides for a substantially linear border. FIG. 12 illustrates the formation of a pattern where two applications of polymer 20 and 24 are applied to a nail 10. On the left side of the figure, a horizontal border 25 is already provided to the right application of polymer 24, while a border for the left application 20 has not yet been defined. A diagonal border 26 is fashioned on the left application of polymer 20 by using the flat gouge to scrape off a portion of the left polymer overlay 20 in a diagonal direction. The horizontal border 25 was formed by using the flat gouge to scrape off a portion of polymer overlay 24 horizontally. In order to provide for a single layer, it will be necessary to apply a polymer application to the nail between the two polymer applications defined thus far.

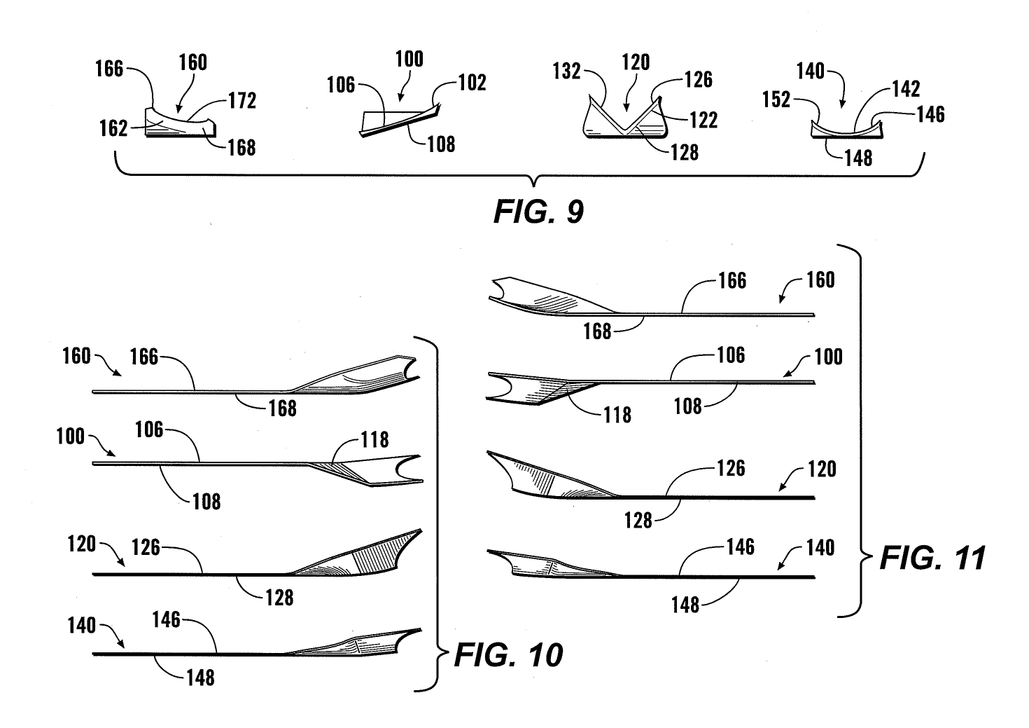

A V-gouge 120, in addition to a concave recess 130 corresponding to the flat gouge concave recess 110, is also crimped to form a top to bottom V-shaped tip 132 as shown in FIGS. 6 and 9. When used, the V-gouge creates a V-shaped border. FIG. 13 illustrates the formation of a pattern where two applications of polymer 20 and 24 are applied to nail 10. On the left side of the figure, a V-shaped border 25′ for the right application of polymer 24 is defined, while a border has not yet been defined for the left application of polymer 20. On the right side of the figure, a complementary V-shaped border 26′ is defined on the left application of polymer 20. The middle section between the two borders can be left unfilled or filled to form a three section pattern of two or more colors. With some imagination, additional patterns can be formed in the middle section.

A crescent gouge 140, in addition to a front to back concave recess 150 similar to that described for the flat gouge and the V-gouge, is bent to form a bottom to top concave crescent-shaped tip 152, as shown in FIGS. 6 and 9. When used, the crescent gouge provides a crescent border. FIG. 14 illustrates the formation of a pattern where two applications of polymer 20 and 24 are applied to nail 10. On the left side of the figure, a crescent-shaped border 25″ for the right application of polymer 24 is defined, while a border has not yet been defined for the left application of polymer 20. On the right side of the figure, a complementary crescent-shaped border 26″ is defined on the left application of polymer 20 is defined by scraping off a portion of the polymer overlay 20 with a crescent gouge.

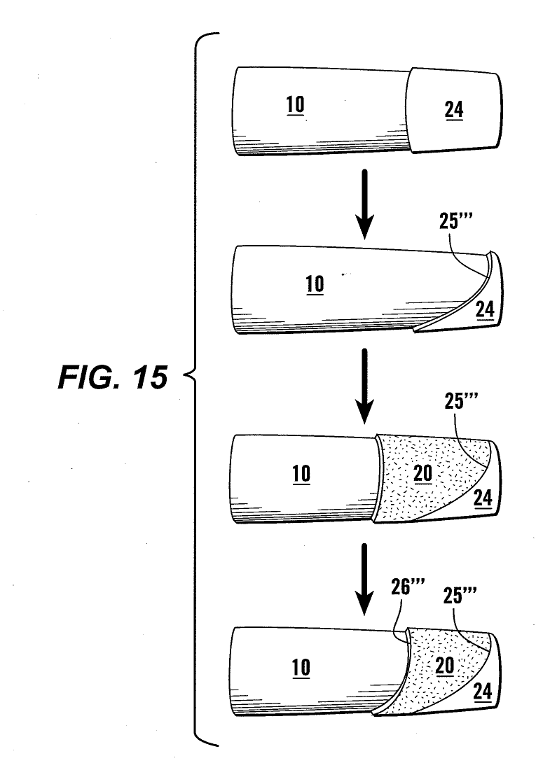

A half-crescent gouge 160, in addition to a front to back concave recess 170 similar to that described for the above-recited gouges, is bent to form a bottom to top concave half-crescent-shaped tip 172, as shown in FIGS. 6 and 9. For the half crescent gouge, there is a left handed gouge and a right handed gouge, depending on the side crimped to form the half crescent. The half crescent gouge allows for the formation of crescent borders other than substantially horizontal crescent borders. Although described as a half-crescent, the degree of crimping may be more or less than half, and need not be exactly take up half of the fashioning end of the gouge. Accordingly, the half-crescent gouge may be better described as having a partially-crescent fashioning end. By crimping only one side, the opposing side is open for the gouge to rotate towards the front or the back of the fingernail. When used, the half-crescent gouge provides for diagonal and optional vertical crescent borders. FIG. 15 illustrates the formation of a pattern where two applications of polymer 20 and 24 are applied to nail 10. From the top of the figure, a right application of polymer 24 is applied to nail 10. Then a diagonal crescent-shaped border 25′″ is defined by a half-crescent gouge. Next, a left application of polymer 20 is applied to abut border 25′″. Finally, another diagonal crescent-shaped border 26″ having a less severe angle is defined on polymer 20 by scraping off a portion of the polymer overlay 20 with the same half-crescent gouge, but rotating the non-crimped side of the fashioning tip to a lesser degree than for border 25′″.

In general, for applying colored patterns using acrylic polymers, the method comprises dipping an application brush in a liquid acrylic monomer. The brush is then dipped in an acrylic polymer powder to form a liquid powder composition. The liquid powder composition is applied to the fingernail (natural, artificial or both) to form a polymer layer. At this point, one of the gouges can be used to define a border on the first application of polymer. The first application can be any color. Once a border is defined on the first application, a second application of acrylic is applied in the manner previously described. Depending on the pattern the manicurist intends to create, the second application of acrylic can be the same or a different color than the first application. Defining a border on the second application of polymer is optional depending on whether or not additional applications of acrylic will follow. It may be necessary to use the brush dipped in liquid monomer to gently fix any imperfections in removal of excess polymer.

After the polymer overlay is applied, it is well-known in the art to file, polish and buff the polymer overlay to produce a smooth, attractive finish. While it is possible to apply a colored fingernail polish over an artificial fingernail fashioned in accordance to the invention, such a polish is generally not necessary. However, a clear coat can be applied to further refine the fingernail.

Finally, all references, including the priority document, cited herein are hereby incorporated by reference. While the present invention has been described in considerable detail, it will be obvious to those skilled in the art that alterations may be made in the gouge itself or in the procedure for using the gouge without departing from the concept and scope of the present invention as described in the following claims.

I claim:

1. A method of forming an artificial nail having multiple colors comprising: 1) applying a first colored polymer to a nail; 2) scraping off a portion of the first colored polymer to define a first border; and 3) applying a second colored polymer to the nail to abut the first border, wherein the second polymer substantially extends the layer formed by the first polymer.

2. The method of claim 1, wherein the polymer is acrylic.

3. The method of claim 1, further comprising defining a second border for the second polymer.

4. The method of claim 3, further comprising applying a third polymer adjacent the second border, such that all three applications of polymer form a substantially contiguous layer.

5. The method of claim 1, wherein a first gouge is used to define the first border, and a differently shaped second gouge is used to define the second border.

6. The method of claim 1, wherein one gouge is used to define both the first border and the second border.

7. The method of claim 1, wherein the first border is selected from a group consisting of a substantially horizontal border, a substantially concave border, a substantially V-shaped border, or a diagonally curved border and the second border a different border selected from the same group.

8. A system for forming artificial nails having multiple colors comprising: 1) a gouge having a front end, a back end, a top and a bottom, wherein the back end has a handle, the front end has a fashioning end, and the fashioning end has a front to back concave recess that generally corresponds to the width and contour of a natural nail; 2) a polymer of a first color; and 3) a polymer of a second color.

9. The system of claim 8, wherein the gouge is selected from the group consisting of a flat gouge, a V-gouge, a half-crescent gouge and a crescent gouge, wherein: the flat gouge has a substantially flat horizontal fashioning end; the V-gouge is crimped to form a substantially bottom to top V-shaped fashioning end; a portion of the front end of the half-crescent gouge is crimped to form a partially crescent fashioning end; and the crescent gouge is crimped to form a substantially bottom to top concave crescent fashioning end.

10. The system of claim 9, wherein the gouge belong to a set of gouges having the same fashioning end, but having varying graduated widths and front to back concave recesses that conform to different sized nails.

11. The system of claim 8, wherein the polymer of a second color is the same color as the first color, but contains a sprinkling of glitter.

12. The system of claim 9, wherein the gouge is part of a set of at least one flat gouge, at least one V-gouge, at least one half-crescent gouge and at least one crescent gouge.

13. The system of claim 9, wherein the gouge is the half-crescent gouge.

14. The system of claim 9, wherein the gouge is the flat gouge.

15. The system of claim 9, wherein the gouge is the V-gouge.

16. The system of claim 9, wherein the gouge is the crescent gouge.

17. The system of claim 8, wherein at least one polymer is an acrylic powder.
